(19) United States
(12) Patent Application Publication
(10) Pub. No.: US 2006/0138997 A1
(43) Pub. Date: Jun. 29, 2006

(54) Power supply for electrochemical ion exchange

(75) Inventors: James Crawford Holmes, San Carlos, CA (US); Joe Evans, Palo Alto, CA (US); Eric Nyberg, Belmont, CA (US)

Correspondence Address: Janah & Associates, P.C., Suite 106, 650 Delancey Street, San Francisco, CA, 94107, US

(73) Assignee: Pionetics Corporation

(21) Appl. No.: 11/024,521

(22) Filed: Dec. 28, 2004

(51) Int. Cl. H02J 7/00

(52) U.S. Cl. 320/103

(57) ABSTRACT

An electrode power supply for an electrochemical ion exchange cell has an output terminal and is capable of receiving an AC voltage and generating a DC voltage at the output terminal for electrodes of the electrochemical ion exchange cell. The electrode power supply comprises a DC voltage supply capable of producing the DC voltage having selectable voltage levels from the AC voltage, a current detector to detect the current level of the DC voltage at the output terminal, a voltage selector to select the voltage level of the DC voltage in relation to the detected current level, and a polarity selector to select the polarity of the DC voltage relative to the output terminal. In one version, a controlled power supply for the ion exchange cell has the electrode power supply and a microcontroller.

### BACKGROUND

Embodiments of the invention relate to a power supply for electrochemical ion exchange.

An electrochemical ion exchange apparatus comprises one or more electrochemical cells and is used to remove or replace ions in a fluid stream, for example, to produce purified water by deionization, treat waste water, or selectively substitute ions in a fluid. A typical cell comprises electrodes about an ion exchange material which removes or replaces ions in an influent solution to form a treated solution. After the cell is used for some time, the ion exchange material is regenerated by reversing the polarity of the voltage applied to the electrodes. The ion exchange material may be a water-splitting ion exchange membrane (also known as a bipolar, double, or laminar membrane) that is positioned between two facing electrodes, as for example, described in commonly assigned U.S. Pat. No. 5,788,826 to Nyberg, issued Aug. 4, 1998, U.S. patent application Ser. No. 10/637,186 to Holmes et al., filed Aug. 8, 2003, and U.S. patent application Ser. No. 10/900,256 to Hawkins et al., filed Jul. 26, 2004, all of which are incorporated herein by reference in their entireties. Electrochemical ion exchange cells are advantageous because they can be used to efficiently treat an influent solution and are easier to regenerate than chemical cells which require chemicals for regeneration.

A power supply is used to apply cell deionization and regeneration voltages to the electrodes of the electrochemical cell. The power supply provides a relatively high voltage to the electrodes and also controls the polarity of the voltage. The voltage level is related to the effectiveness of the electrochemical cell at removing or replacing ions, and the polarity is switched to select de-ionization or regeneration of the cell. As there may be a tendency for the current delivered to the cells to increase beyond desirable limits, due to, for example, an electrical short or a transient low resistance pathway it is also desirable for the power supply to monitor and limit the current supplied to the electrodes. Furthermore, the power supply should also be cost and energy efficient, as ion exchange apparatuses are often used for fluid treatment in economically-developing product markets.

Power supplies have been developed for use with ion exchange apparatuses. For example, U.S. Pat. No. 5,055,170 to Saito, issued Oct. 8, 1991, which is incorporated herein by reference in its entirety, discloses a circuit for applying a DC voltage between electrodes in an electrolytic cell having an ion-exchange membrane. The circuit has a transformer to step down an AC voltage, which is then rectified and supplied to the collector of an NPN transistor whose emitter is connected to the positive electrode of the electrolytic cell. The base of the NPN transistor is driven by a control circuit which receives an input based on a measured voltage drop in the cell. However, there are disadvantages of this circuit, for example the output DC voltage is limited in value to the voltage level of the rectified stepped down voltage. Thus, the output DC voltage will never be greater in value than the amplitude of the available AC voltage. Furthermore, the use of a transformer in the circuit driving the electrodes may be undesirable due to the potentially high cost and weight of such a component. Additionally, Saito provides no means to monitor and limit the current delivered to the electrode.

In another example, U.S. Pat. No. 4,012,310 to Clark et al., which is incorporated herein by reference in its entirety, discloses a high voltage supply for an electrode of an electrostatic water treatment system. The high voltage supply of Clark et al. comprises a DC multiplier having a center-tapped transformer fed by a transistor oscillator and a DC power supply. The action of the transistor oscillator serves to turn the multiplier on and off to conserve energy, resulting in the charging and discharging of a capacitance between the electrode and a shell around the electrode. However, the use of a transformer, as in the circuit of Saito, is undesirable. The high voltage supply of Clark et al. also has an over current protection which turns off the high voltage supply in the event of an excessive current delivered to the electrode. However, it is undesirable to completely shut down the power delivery to the electrostatic water treatment system, as a complete shutdown will incur an undesirable transient startup time to begin water treatment after the shutdown. Furthermore, the high voltage supply of Clark et al. does not generate a DC voltage which has a selectable voltage level.

Another problem is that electrode power supplies typically require the use of components that are rated to withstand the full value of the voltage generated by the power supply. However, as the power supply becomes capable of producing relatively higher voltage levels, the components are required to be rated for these higher voltages which increase their cost of fabrication. Thus, the benefit of an electrode power supply to deliver a relatively higher output voltage is usually offset by the cost of the components of such a power supply.

Thus, it is desirable to have a power supply for an ion exchange apparatus capable of delivering a DC voltage having a relatively high selectable voltage level to electrodes of electrochemical ion exchange cells. It is also desirable to have a power supply that limits the current supplied to the electrodes without completely turning off the current. It is further desirable to have a power supply that does not include expensive components. It is also desirable to have an energy efficient power supply.

### SUMMARY

An electrode power supply for an electrochemical ion exchange cell has an output terminal and is capable of receiving an AC voltage and generating a DC voltage at the output terminal for electrodes of the electrochemical ion exchange cell. The electrode power supply comprises a DC voltage supply capable of producing the DC voltage having selectable voltage levels from the AC voltage, a current detector to detect the current level of the DC voltage at the output terminal, a voltage selector to select the voltage level of the DC voltage in relation to the detected current level, and a polarity selector to select the polarity of the DC voltage relative to the output terminal.

A controlled power supply for an ion exchange apparatus has an electrode power supply, a supplemental power supply, and a microcontroller. The ion exchange apparatus comprises a valve with a motor and electrochemical ion exchange cell which has electrodes. The electrode power supply has an output terminal and is capable of receiving an AC voltage and generating a DC voltage at the output terminal for the electrodes at the output terminal. The electrode power supply comprises the DC voltage supply, current detector, voltage selector, and polarity selector. The supplemental power supply generates a supplemental DC voltage for the electric motor, and low voltage power for the microcontroller, its inputs and outputs and sensors. The microcontroller generates control signals for the electrode power supply and the electric motor.

An ion exchange apparatus comprises an electrochemical cell, a valve, a motor, and a controller. The electrochemical cell has a fluid channel comprising a fluid inlet and a fluid outlet, electrodes about the fluid channel, and a water-splitting ion exchange membrane. The valve controls the flow of a solution through the fluid inlet, fluid outlet, and the fluid channel of the electrochemical cell. The electric motor moves a rotor in the valve. The controller is capable of controlling the operation of the electrochemical cell, the valve and the electric motor. The controller comprises a power supply having an electrode power supply and a supplemental power supply. The electrode power supply has an output terminal and is capable of receiving an AC voltage and generating a DC voltage for the electrodes at the output terminal. The electrode power supply comprises the DC voltage supply, the current detector, the voltage selector, and the polarity selector. The controller also has a control module having a microcontroller to generate control signals for the power supply and the electric motor.

A method of maintaining a selectable voltage across electrodes of an electrochemical cell comprises rectifying an AC voltage and multiplying the rectified voltage to produce a pulsating DC voltage having a time-averaged value equal to the amplitude of the AC voltage multiplied by a multiplier M₁, applying the pulsating DC voltage across the electrodes, measuring the current level delivered to the electrodes, and setting the value of the multiplier M₁ in relation to the measured current level.

Another method of maintaining a selectable voltage across electrodes of an electrochemical cell comprises rectifying an AC voltage and multiplying the rectified voltage to produce a pulsating DC voltage having a time-averaged value equal to the amplitude of the AC voltage multiplied by a multiplier M₁, applying the pulsating DC voltage across the electrodes and maintaining a selected polarity of the DC voltage across the electrodes, sensing a property of the electrochemical cell, and selecting the value of the multiplier M₁ and the polarity of the pulsating DC voltage across the electrodes in relation to the sensed property of the electrochemical cell.

### DRAWINGS

These features, aspects and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a schematic view of an embodiment of an ion exchange apparatus;

FIG. 2 is a schematic view of an embodiment of a controller for the ion exchange apparatus illustrated in FIG. 1;

FIG. 3 is a schematic view of an embodiment of a controlled electrode power supply of the controller of FIG. 1;

FIG. 4 is a circuit schematic of an embodiment of an adjustable-hysteresis rectifier of the electrode power supply illustrated in FIG. 3;

FIG. 5 is a circuit schematic of an embodiment of a voltage multiplier of the electrode power supply illustrated in FIG. 3;

FIG. 6 is a circuit schematic of an embodiment of a current detector of the electrode power supply illustrated in FIG. 3;

FIG. 7 is a circuit schematic of an embodiment of a polarity selector of the electrode power supply illustrated in FIG. 3;

FIG. 8 is a circuit schematic of an embodiment of a zero-crossing detector of the electrode power supply illustrated in FIG. 3;

FIG. 9 is a circuit schematic of an embodiment of a resistor portion of the capacitor and switched-resistor network of the electrode power supply illustrated in FIG. 3;

FIG. 10 is a circuit schematic of an embodiment of a timer of the electrode power supply illustrated in FIG. 3; and

FIG. 11 is a circuit schematic of an embodiment of a supplemental power supply of the power supply illustrated in FIG. 3.

### DESCRIPTION

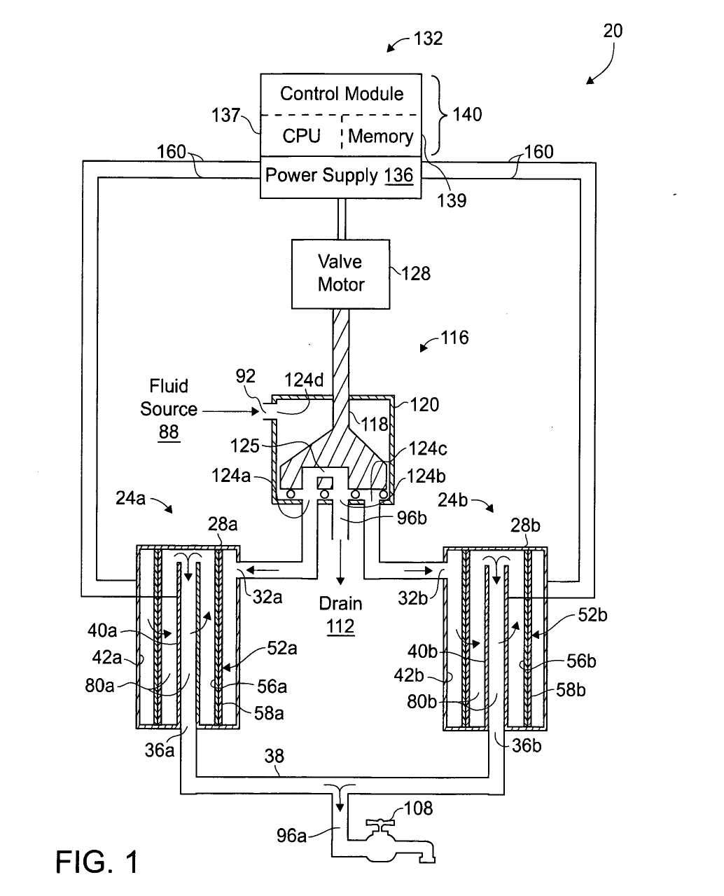

An embodiment of an ion exchange apparatus 20, illustrated schematically in FIG. 1, is capable of treating a fluid comprising ions to extract, replace, or add ions to generate a treated fluid having desired ion concentrations. The ion exchange apparatus 20 is useful for treating fluids, such as for example, water, to remove impurities, minerals, metals, salts, acids and bases which is useful to create, for example, potable water. Treatment of other fluids, such as brine, can also be useful to create drinking water. Exemplary embodiments of the ion exchange apparatus 20 and its components provided herein are to illustrate the invention and should not be used to limit the scope of the invention, and alternative arrangements and configurations as would be apparent to those of ordinary skill in the art are within the scope of the invention.

The ion exchange apparatus 20 comprises at least one electrochemical ion exchange cell 24, and more typically a plurality of electrochemical ion exchange cells 24a,b, as shown. Generally, each ion exchange cell 24a,b comprises a housing 28a,b that is an enclosed leak-proof structure having at least one fluid inlet 32a,b and at least one fluid outlet 36a,b. A suitable housing 28a,b typically comprises a cylinder with a cap (as shown) or a plate and frame construction fabricated from metal or plastic. While one or more fluid outlets 36 can be provided, the fluid exiting the fluid outlets 36a,b from the housings 28a,b preferably comprises a single fluid stream that is formed before or after the outlets 36a,b, for example in a exhaust manifold 38 that combines the different fluid streams. Optionally, the ion exchange apparatus 20 can include a pump (not shown), such as for example, a peristaltic pump, or water pressure from a city water supply in combination with a flow control device (not shown) can be used to pump the fluid stream through the cells 24a,b.

Each electrochemical ion exchange cell 24a,b has first and second electrodes 40a,b and 42a,b within the housings 28a,b, respectively. The electrodes 40a,b and 42a,b can be discrete structures separate from the housings 28a,b, for example, the electrode 40a is a metal layer or tube inside the housings 28a,b, as shown in FIG. 1, and the electrodes 42a,b are electrically conducting walls of the housings 28a,b. Typically, the electrodes 40,42 have conducting surfaces that face one another. The first and second electrodes 40,42 serve as an anode and cathode or vice versa depending on the polarity of the voltage applied to the electrodes. The electrodes 40,42 are fabricated from electrically conductive materials, such as metals which are preferably resistant to corrosion in the low and/or high pH chemical environments that may be created during operation of the cells 24a,b. Suitable electrodes 40,42 can be fabricated from corrosion-resistant materials such as titanium or niobium, and can have an outer coating of a noble metal, such as platinum. The shape of the electrodes 40,42 depend upon the design of the electrochemical cells 24a,b and the conductivity of the fluid flowing through the cell 24a,b. Suitable electrodes 40a,b can be shaped as concentric cylindrical tubes that provide a uniform voltage across their surfaces in a cylindrical cell 24a,b, and that can have openings to allow fluid to pass therethrough. In another arrangement, the electrodes 40,42 can be shaped as spirals, discs, even conical shapes and can be wire forms.

One or more water-splitting ion exchange membranes 52a,b are between the first and second electrodes 40,42 in each ion exchange cell 24a,b. The membranes 52a,b comprise an anion exchange layer 56a,b facing the first electrode 40a,b and a cation exchange layer 58a,b facing the second electrode 42a,b, as shown in FIG. 1, or vice versa. The water-splitting membranes 52 comprise abutting anion and cation layers 56,58 contained in an open frame positioned between the electrodes 40,42. Preferably, each cell 24 comprises a plurality of such water splitting membranes 52 arranged in a wrapped spiral configuration, as for example described in aforementioned U.S. Pat. No. 5,788,826. In this configuration, sheets of membranes 52 are wrapped around one another with gaps in-between that can be filled with a porous material or spacer (not shown). The edges of the wrapped membranes are spaced apart to overlap one another to allow the fluid being treated to pass between the membranes 52 to form treated fluid exiting within the central channel 62a,b of each cell 24a,b.

Suitable anion exchange layers 56 of the water-splitting membrane 52 comprise one or more basic functional groups capable of exchanging anions such as—NR₃A, —NR₂HA, 13 PR₃A, 13 SR₂A, or C₅H₅NHA (pyridine), where R is an alkyl, aryl, or other organic group and A is an anion (e.g., hydroxide, bicarbonate, chloride, or sulfate ion). The choice of anion exchange functional group also depends on the application. Suitable cation exchange layers 58 can comprise one or more acidic functional groups capable of exchanging cations such as —COOM, —SO₃M, —PO₃M₂, and —C₆H₄OM, where M is a cation (e.g., hydrogen, sodium, calcium, or copper ion). Cation exchange materials also include those comprising neutral groups or ligands that bind cations through coordinate rather than electrostatic or ionic bonds (for example pyridine, phosphine and sulfide groups), and groups comprising complexing or chelating groups (e.g., those derived from aminophosphoric acid, aminocarboxylic acid, and hydroxamic acid). The choice of cation exchange functional group depends upon the application of the cell. The water-splitting ion exchange membrane 52 can also comprise multiple anion and one cation exchange layers 56, 58, that have different ion exchange capacities or ion exchange functional groups

A fluid channel 80a,b in the housings 28a,b allows influent fluid from the fluid inlet 32a,b to flow past both the anion and cation exchange layers 56, 58 of the water-splitting ion exchange membrane 52 to form the effluent fluid at the fluid outlet 36. The flow path of fluid channels 80a,b can be defined by the housings 28a,b and the structures in the housings 28a,b. For example, the channels 80a,b can be formed between the surfaces of the water-splitting membranes 52a,b, and the electrodes 40,42, of the housings 28a,b, as shown in FIG. 1. The fluid channels 80a,b extend from the inlets 32a,b to the outlets 36a,b which output treated fluid.

The ion exchange apparatus 20 receives an untreated fluid stream through an apparatus fluid inlet 92 from a fluid source 88 such as, for example, a city water supply or a natural water source such as a stream, lake, spring or well. The apparatus 20 releases fluid which has undergone a desired ion exchange process through at least one apparatus fluid outlet 96a to a treated fluid output 108 which can be, for example, a faucet or fluid storage tank. The apparatus 20 also releases untreated fluid, which has not undergone an ion exchange process, selected ion exchange, or used to regenerate the ion exchange cell, through a second fluid outlet 96b to a drain 112. The drain 112 can be a drain of a house or a tank.

The ion exchange apparatus 20 comprises a valve 116 to control the flow of fluid through the ion exchange apparatus 20 and between components of the ion exchange apparatus 20, such as the ion exchange cells 24a,b, the untreated fluid source 88, the treated fluid output 108, and the untreated fluid output 112. For example, the valve 116 is capable of controlling fluid flow through the fluid inlets 32a,b, fluid outlets 36a,b, and fluid channels 80a,b of the ion exchange cells 24a,b. Generally, the valve 116 comprises an enclosed housing 120 that can contain the fluid without leakage. The housing 120 has a plurality of ports 124 through which fluid can enter and leave the valve 116 via predetermined pathways that are set or controlled by the valve 116. The ports 124 are fluidly connected to components of the ion exchange apparatus 20. For example, in the schematic illustration of the connections to the valve 116 shown in FIG. 1, the ports 124 of the valve 116 are connected to the fluid inlets 32a,b of the ion exchange cells 24a,b, the fluid inlet 92 of the ion exchange apparatus 20 which receives a fluid flow from the fluid source 88, and the second fluid outlet 96b of the ion exchange apparatus 20 fluidly connected to the fluid output 112.

In one version, the valve 116 comprises a rotor 118 that can be rotated to by a valve motor 128 to align internal passages 125 of the rotor 118 in such a way that the flow of fluid is directed through the valve 116 to the outlets 124a-c in a selectable manner. For example, the rotor 118 can be aligned such that, for example, fluid flow between a first port 124a and a second port 124b or 124c is enabled or disabled by the passage 125. The valve 116 may also have alternative configurations in which the moving component of the valve 116 is not a rotor, but instead is a piston (not shown) that slides back and forth to direct a fluid flow, or a lever (not shown) that is moved to direct a fluid flow. Instead of a rotor 118 the valve can also have a movable element that is shaped in another form, such as a linear or plate member. For example, the valve 116 can be a solenoid valve (not shown) capable of opening and closing passages by using a magnetic field to move a steel plug in and out to align passages 125 and openings 124. Suitable valves are described in U.S. patent application filed on Dec. 23, 2004, entitled, FLUID FLOW CONTROLLING VALVE HAVING SEAL WITH REDUCED LEAKAGE (attorney docket no Pion.4.US) which is incorporated herein by reference in its entirety.

The valve motor 128 moves the rotor 118 of the valve 116 or other movable element, to enable or disable fluid communication between the passage 125 and the ports 124a-d of the valve 116. The motor 128 attaches to the rotor 118 and is capable of receiving signals to rotate or slide the rotor 118 in a selected direction at a selected speed and for a selected time. The motor 128 is also adaptable to other configurations of the valve 116, such as configurations in which the moving part of the valve 116 is not a rotor, but is instead, for example, a sliding piston or a lever. The motor 128 can be, for example, an electric motor or solenoid.

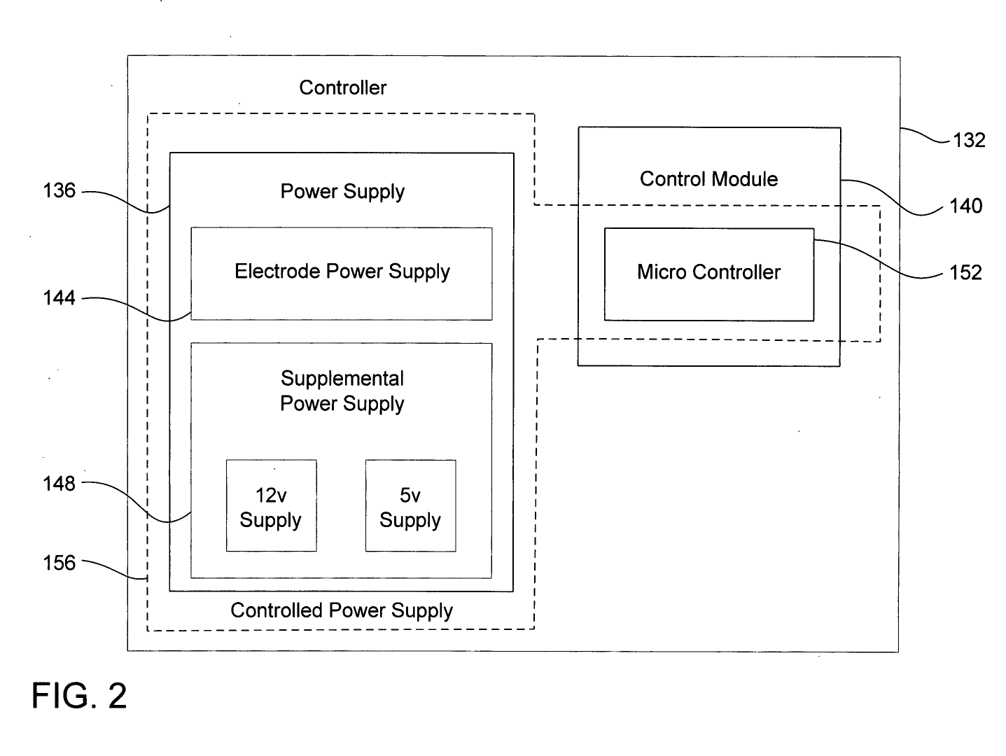

The ion exchange apparatus 20 comprises a controller 132 which controls the operation of the apparatus 20 and supplies control signals and power to components of the apparatus 20. In one version, as illustrated schematically in FIG. 2, the controller 132 comprises a power supply 136 and a control module 140. The power supply 136 is capable of generating voltages to deliver power to components of the ion exchange apparatus 20. The voltage levels generated by the power supply 136 are selectable to deliver power to components of the apparatus 20 depending upon, for example, the component requirements, the operating conditions of the ion exchange apparatus 20, or other factors. For example, the power supply 136 comprises an electrode power supply 144 to generate a voltage to deliver power to the electrodes 40 of the electrochemical ion exchange cell 24. In one version, the power supply 136 may also comprise a separate supplemental power supply 148, or a plurality of such supplemental power supplies 148, tailored to specific components or functions. In one version, the electrode power supply 144 generates a relatively high voltage to deliver power to the electrodes 40 and the supplemental power supply 148 generates relatively low voltages to deliver power to components such as the electric motor 128, components of the controller 132, and other components in the ion exchange apparatus 20 requiring power.

The control module 140 is capable of generating and receiving signals and instructions to individually and collectively operate components of the ion exchange apparatus 20. The control module 140 comprises electronic circuitry and program code to receive, evaluate, and send signals. For example, the control module 140 can comprise (i) a programmable integrated circuit chip or a central processing unit, CPU 137, (ii) a memory 139 such as a random access memory and stored memory, (iii) peripheral input and output devices (not shown) such as keyboards and displays, and (iv) hardware interface boards (not shown) comprising analog, digital input and output boards, and communication boards. The control module 140 can also comprise program code instructions stored in the memory that are capable of controlling and monitoring the ion exchange cell 24, power supply 136, and other components of the ion exchange apparatus 20. The program code may be written in any conventional computer programming language. Suitable program code is entered into single or multiple files using a conventional text editor and stored or embodied in the memory. If the entered code text is in a high level language, the code is compiled, and the resultant compiler code is then linked with an object code of pre-compiled library routines. To execute the linked, compiled object code, the user invokes the object code, causing the CPU to read and execute the code to perform the tasks identified in the program.

In one version, the control module 140 comprises a microcontroller 152. The microcontroller 152 is typically a single integrated device that comprises several of the components of the control module 140. For example, the microcontroller 152 may comprise a CPU, memory, program code, input and output circuitry, and other circuitry that may be specialized or adapted to particular tasks. The microcontroller 152 is advantageous because it encapsulates a relatively high degree of functionality into a single programmable component. One example of suitable commercially available microcontrollers 152 are the PICmicro® series of microcontrollers, such as for example the 28/40-Pin 8-Bit CMOS Flash PIC16F87X Microcontroller, available from Microchip located in Chandler, Ariz. Another example of a suitable commercially available microcontroller 152 is the 68000 available from Motorola Corp., Phoenix, Ariz.

In one version, the power supply 136 and a portion of the control module 140, such as the microcontroller 152, can together form a controlled power supply 156. The controlled power supply 156 combines the generation of voltages and current to deliver power to the components of the ion exchange apparatus with the programmability and control functionality of the microcontroller 152. The controlled power supply 156 may also be part of a controller 132 having a control module 140 and other components besides the microcontroller 152.

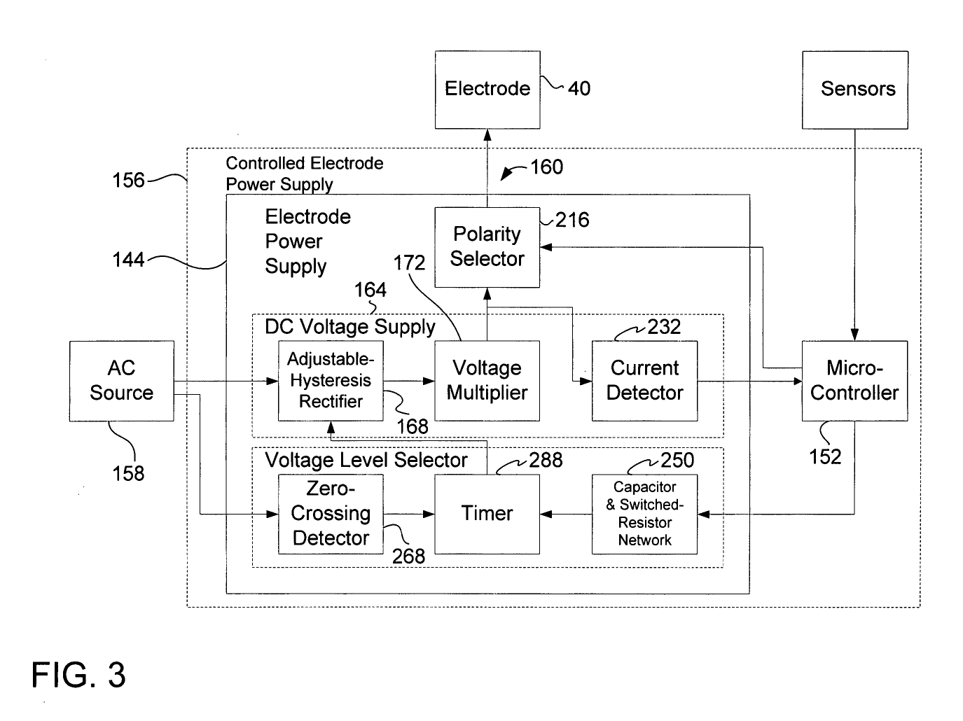

The electrode power supply 144, a schematic view of which is illustrated in FIG. 3, is capable of generating a DC voltage having a selectable voltage level for the electrode 40. The selection of the voltage level may be in relation to the current level delivered by the electrode power supply 144 to the electrode 40, or in relation to another property of the electrode 40, the electrochemical ion exchange cell 24, or another component of the ion exchange apparatus 20. The electrode power supply 144 is capable of receiving an AC voltage from an AC source 158 and generating the DC voltage across a pair of terminals 160 for the electrodes 40 of the electrochemical cell 24. The DC voltage may, for example, be a pulsating DC voltage, having an amplitude and a ripple. In one version, the ripple has a value of from about 10% to about 50% of the time-averaged value of the DC voltage during a specified time period. In one version, the electrode power supply 144 is capable of generating the DC voltage which has a voltage level which is typically selectable in the range of from about 0 V to about 330 V, or from about 30 volts to 300 volts.

The electrode power supply 144 comprises a DC voltage supply 164 to generate the DC voltage. The DC voltage supply 164 is capable of receiving the AC voltage and a signal to select the DC voltage level, and generating the DC voltage in response to these inputs. In one version, the DC voltage supply 164 comprises a rectifier 168 to rectify the AC voltage and a voltage multiplier 172 to multiply the rectified voltage to generate the DC voltage having a selectable voltage level.

The rectifier 168 is capable of generating a rectified voltage from the AC voltage over a first portion or percentage P₁ of the period of the input AC voltage, and over a second portion or percentage P₂ of the period of the AC voltage, the rectifier 168 is capable of not generating a rectified voltage. For example, during the second portion of the period of the AC voltage, in one version, the rectifier 168 is capable of generating a voltage having a value of about 0V. The rectifier 168 can have an adjustable input voltage hysteresis which controls the relative size of the first and second percentages P₁, P₂ of the period of the AC voltage over which the rectifier 168 is capable of different behavior. The value of the input voltage hysteresis of the rectifier 168 is the difference between a first AC voltage value input to the rectifier 168 that causes the rectifier 168 to turn on and conduct to produce a rectified voltage, and a second AC voltage value input to the rectifier 168 that causes the rectifier 168 to turn off and not conduct and not produce a rectified voltage, or to produce voltage having a value of about 0V. The first and second voltages are different voltages —which makes the rectifier an adjustable hysteresis rectifier. By adjusting the input voltage hysteresis of the rectifier 168, the time-averaged voltage level of the rectified voltage can be adjusted. In one version, the rectifier 168 is capable of receiving a trigger signal which can be used to adjust the input voltage hysteresis of the rectifier 168.

The adjustable-hysteresis rectifier 168 operates asymmetrically with respect to turning on and turning off because the rectifier 168 turns on when the AC voltage input to the rectifier 168 reaches a first level, but does not turn off when the input AC voltage goes below this first level (as it would in a symmetric device). Instead, the input AC voltage has to drop below a second level for the rectifier to turn off. Usually, the second level is lower in magnitude that the first level. Thus, the adjustable-rectifier 168 has a hysteresis which makes it harder to turn off than to turn on, or the other way around. A measure of the hysteresis is the difference in voltage levels between a first voltage level which causes the rectifier 168 to turn on and a second voltage level which causes the rectifier to turn off. Furthermore, in the adjustable-hysteresis rectifier 168, the amount of hysteresis that the rectifier exhibits can be adjusted or changed. The amount of hysteresis that the power supply 144 exhibits controls the level of the approximately DC output voltage that the power supply supplies to the electrodes. Increasing the amount of hysteresis increases the level of DC output voltage supplied to the electrodes, and decreasing the amount of hysteresis decreases the level of the DC output voltage, or vice versa, that is increasing the hysteresis decreases the DC output voltage level. The hysteresis is adjusted through a trigger signal supplied to the rectifier 168. The trigger signal is a different signal than the AC input voltage supplied to the rectifier. Thus, a rectifier 168 comprising SCRs behaves approximately like diodes, except it also has a trigger input. Thus, such a rectifier 168 can function as normal diodes as long as it has a certain trigger signal, and if the rectifier 168 does not receive a particular trigger signal, it will not turn on, even with an input voltage that would cause a normal diode to turn on. Adjusting the hysteresis of the adjustable-hysteresis rectifier 168 is accomplished by adjusting the trigger signal supplied to the rectifier.

The voltage multiplier 172 generates the DC voltage from the rectified voltage. The DC voltage has a time-averaged value equal to the amplitude of the AC voltage multiplied by a multiplier M₁. The multiplier M₁ is a function of both the multiplication generated by the voltage multiplier 172 and the adjustability of the time-averaged voltage level of the rectified voltage. In one version, the voltage multiplier 172 is a voltage doubler 172, which will generate a DC voltage having a time-averaged magnitude of approximately double the amplitude of a full-wave rectified voltage not exhibiting an input voltage hysteresis. In this version, the multiplier M₁ is equal to about 2 times a second multiplier M₂, or M₁=2*M₂. The second multiplier M₂ is representative of the adjustability of the time averaged value of the rectified voltage. For example, the AC voltage can have an amplitude of from about 80 V to about 480 V, and the multiplier M₁ can have a value of from about 2 to about 5.

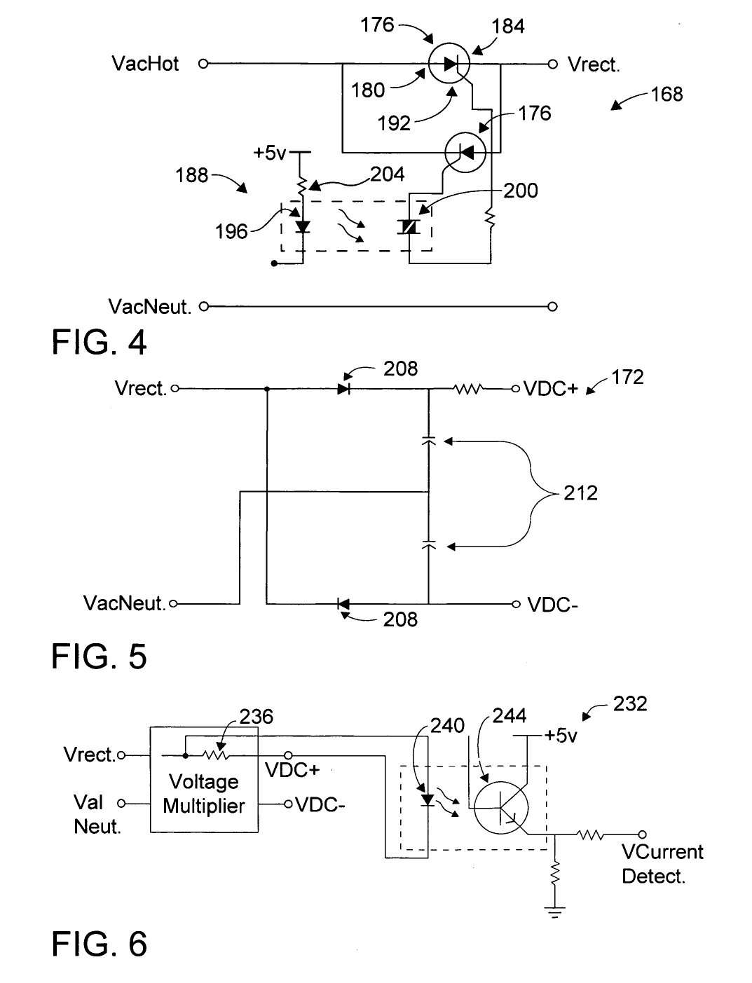

One version of the rectifier 168 is illustrated in the circuit schematic of FIG. 4. The rectifier 168 receives the AC voltage at the nodes labeled V_{AC,HOT}-V_{AC,NEUT}. and produces the rectified voltage at the node V_{RECT}. In this version, the rectifier 168 comprises a pair of silicon-controlled rectifiers (SCRs) 176 arranged to provide full wave rectification. For example, in the version show, the SCRs 176 are arranged in parallel with opposing orientations of the anode 180 and cathode 184. Alternately, a TRIAC (not shown), which typically comprises the functionality of a pair of SCRs integrated into a single device, may be used in place of the pair of SCRs 176. The TRIAC is advantageous because it is less expensive; however, the TRIAC circuitry is more sensitive to values of other circuit components and voltage fluctuations. The use of a pair SCRs 176 is advantageous because they are less sensitive to the variability of other circuit components, and consequently, more robust.

The rectifier 168 also comprises a trigger circuit 188 to receive the trigger signal and to turn on the SCRs 176 to rectify the AC voltage. For example, in the version show, the trigger circuit 188 receives the trigger signal at the node labeled V_{TRIGGER}. In operation, at least one of the pair SCRs 176 will conduct and produce a rectified voltage when the trigger circuit 188 receives a first value of the trigger signal, and neither of the SCRs 176 will conduct and thus not produce a rectified voltage when the trigger circuit 188 receives a second value of the trigger signal. The trigger circuit 188 is capable of receiving the trigger signal and supplying the gates 192 of the SCRs 176 with an appropriate voltage signal to cause the SCRs 176 to conduct. Thus, in this version, the hysterisis of the rectifier 168 is generated by the hysterisis of the SCRs 176. Also, in this version, the hysterisis of the rectifier 168 is adjusted by adjusting the trigger signal. In one version, the trigger circuit 188 comprises an LED 196 which is optically coupled to a photo-DIAC 200. The photo-DIAC 200 in turn is connected to the gates 192 of the SCRs 176, either directly or through a resistor 204. This configuration of the trigger circuit 188 is advantageous because it is independent of operation of the microprocessor; however, the timing signal of the microprocessor can also be used to trigger the photo-DIAC 200.

One version of the voltage multiplier 172 is illustrated in the circuit schematic view of FIG. 5. The voltage multiplier 172 receives the rectified voltage at the node V_{RECT} and the neutral terminal of the AC voltage at the node V_{NEUT}. The voltage multiplier 172 comprises a diode 208 and a plurality of capacitors 212. In one version, the voltage multiplier 172 may comprise a plurality of diodes 208. The voltage multiplier 172 generates the DC voltage across the plurality of capacitors 212. In the version shown, the voltage multiplier 172 is a voltage doubler 172, and comprises a pair of diodes 208 and a pair of capacitors 212. The DC voltage generated by the voltage doubler 172, which has a magnitude of about double the amplitude of the full-wave rectified voltage with no hysteresis, is generated across the pair of capacitors 212, between the nodes labeled V_{DC+} and V_{DC+}. For example, in the version show, each diode 208 is connected to one of the capacitors 212 to generate a portion of the DC voltage by pumping current into or out of that capacitor 212. Thus, each capacitor 212 receives a current input for each half wave of the full wave rectified voltage, and taken together, the voltage across the capacitors 212 is about double the amplitude of the rectified voltage in the case where there is no input hysteresis.

The DC voltage supply 164 has several aspects that provide beneficial cost savings. In one aspect, the DC voltage supply 164 is absent a transformer which is relatively expensive and adds weight, and thus, undesirable in many applications. For example, cost and weight are both important considerations in rural, poor, and developing communities, which is one important market for an ion exchange apparatus, for example, for the treatment of local water to create potable water. In another aspect, electric and electronic components are typically rated to operate at up to a specified voltage level. Above this level, the components may experience reduced performance or failure. In general, a component having a higher voltage rating is more expensive to produce or obtain than a component having a lower voltage rating. The DC voltage supply 164 show in FIGS. 4 and 5, and the electrode power supply 144 in general, may advantageously comprise components which are rated to operate at a voltage level is that is only about half of the level of the full DC voltage generated. The components are advantageously only exposed to voltages having a voltage level of about half of the level of the full DC voltage level generated by the DC voltage supply. For example, the neutral node of the AC voltage, V_{AC,NEUT.}, is connected between the capacitors 212 of the voltage multiplier 172 and the DC voltage generated thus has a value which is numerically centered about the negative AC node.

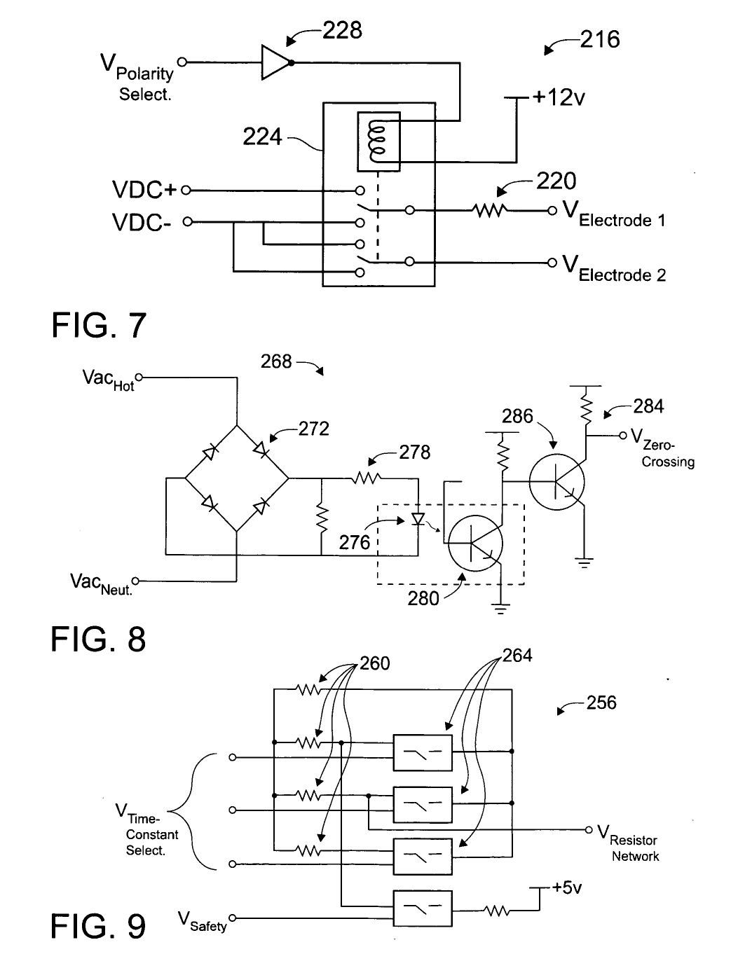

The electrode power supply 144 also comprises a polarity selector 216 to select the polarity of the DC voltage signal relative to the pair of output terminals 160. The polarity selector 216 connects the DC voltage to the output terminals 160 either directly or through a resistor 220. The polarity selector 216 is capable of receiving the DC voltage from the DC voltage supply 164 and a polarity selection signal to select the polarity of the DC voltage. In one version, as illustrated in the circuit schematic of FIG. 7, the polarity selector 216 comprises a relay 224 that receives the DC voltage and the polarity selection signal. A first value of the polarity selection signal causes the relay 224 to connect the DC voltage to the output terminals 160 such that the DC voltage has a first polarity relative to the output terminals 160. A second value of the polarity selection signal causes the relay 224 to connect the DC voltage to the output terminals 160 such that the DC voltage has a second polarity relative to the output terminals 160. The relay 224 receives the polarity selection signal either directly or, as shown in FIG. 7, through a buffer or inverter 228, at the node labeled V_{POLARITY SELECT}. The DC voltage is connected to the output terminals 160 of the electrode power supply 144 between V_{ELECTRODE 1} and V_{ELECTRODE 2}. In one version, the relay 224 is a double pole-double throw relay that breaks the circuit before it makes the circuit to avoid direct electrical shorts. In one version, the polarity selector 216 receives the polarity selection signal from the control module 140. For example, the controller 132 may comprise a controlled power supply 156 in which the polarity selector 216 receives the polarity selection signal from the microcontroller 152. MOSFET components can also be used instead of relays.

The electrode power supply 144 also comprises a current detector 232 to detect the current level delivered to electrode 40 in association with the DC voltage, and generate a current detection signal in relation to the detected current level. In one version, the current detector 232 comprises a sense resistor 236, a light-emitting diode (LED) 240 connected across the sense resistor 236, and a photo-transistor 244 optically coupled to the LED 240. The sense resistor 236 is arranged in series with one node of the DC voltage delivered to the output terminals 160, and may coincide with a series output resistor used by the DC voltage supply 164 for similar or alternative purposes. The sense resistor 236 is able to hold its resistance stable under a wide range of voltage, current or temperature conditions. In one version, the sense resistor 236 has a value of from about 0.1 Ohms to about 10 Ohms, and a suitable value is 1 Ohm. The current level running through the sense resistor 236 is coupled to the photo-transistor 244, which is in a common-collector or emitter-follower configuration, to generate the current detection signal at the node V_{CURRENT DETECT}. In one version, the current detector 232 generates the current detection signal and the control module 140 is capable of receiving the current detection signal. For example, the controller 132 may comprise a controlled power supply 156 in which the current detector 232 generates the current detection signal and the microcontroller 152 is capable of receiving the current detection signal.

The electrode power supply 144 comprises a voltage level selector 248 to select the voltage level of the DC voltage by providing the trigger signal to the rectifier 168. The trigger signal generated by the voltage level selector 248 is in relation to the current detection signal generated by the current detector 232. The trigger signal is generated to trigger the trigger circuit 188 in such a way as to provide the degree of hysteresis in the rectifier 168 suitable to select the desired voltage level of the DC voltage. For example, the trigger signal can be generated to select the value of the second multiplier M₂ to select the level of the DC voltage. In one version, the voltage level selector 248 is capable of receiving a signal from the microcontroller 152 which is based on the current detection signal. For example, the controller 132 may comprise a controlled power supply 156 in which the voltage level selector 248 receives a time-constant selection signal from the microcontroller 152 which is based on the current detection signal. The voltage level selector 248 is also capable of receiving the AC voltage and generating the trigger signal in relation to both the time-constant selection signal and the AC voltage.

In one version, the voltage level selector 248 comprises a capacitor and switched resistor network 250 having an associated time constant t_{RC}. The time constant t_{RC} of the capacitor and switched resistor network 250 is equal to R_{EQ}C_{EQ}, where R_{EQ} is the equivalent resistance of the switched-resistor portion 256 of the network 250 and C_{EQ} is the equivalent capacitance of the capacitor portion 252 of the network 250. The resistor and capacitor portions 256, 252 of the network 250 may be electrically connected together, or may be independently connected to another component of the electrode power supply 144 that is capable of utilizing their equivalent resistance R_{EQ} and capacitance C_{EQ} values. The value of the time constant t_{RC} is selectable and used to generate an appropriate trigger signal to select the level of the DC voltage. In one version, the capacitor and switched resistor network 250 is capable of receiving a signal to select the value of the time constant t_{RC}. For example, the controller 132 may comprise a controlled power supply 156 in which the capacitor and switched resistor network 250 receives the time constant selection signal from the microcontroller 152.

One version of the switched-resistor portion 256 of the network 250 is illustrated in the circuit schematic of FIG. 9. In this version, the switched resistor portion 256 of the network 250 comprises a plurality of resistors 260 arranged in parallel, and at least some of the resistors 260 having a relay 264 in series with that resistor 260. The relays 264 are capable of removing or adding resistors 260 to the plurality of parallel resistors 260 in response to the time-constant selection signal. Thus the equivalent resistance R_{EQ} and also the time constant t_{RC} is selected by the addition or removal of resistors 260 from the plurality of parallel resistors 260 by the time-constant selection signal. In one version, the switched-resistor portion 256 of the network 250 also comprises a node, V_{SAFETY}, which is capable of receiving a selection-safety signal to safely control the addition and removal of resistors 260 to the plurality of parallel resistors 260. For example, the selection-safety signal allows the resistors 260 to be safely switched in and out of the switched-resistor portion 256 of the network 250 without generating undesirable transient currents or voltage spikes which may cause arcing or other safety or performance issues. In one version, the node V_{SAFETY}, is capable of receiving a selection-safety signal from the microcontroller 152.

In one version, the voltage level selector 248 also comprises a zero-crossing detector 268 to generate a zero-crossing signal. The zero-crossing detector 268 is capable of receiving the AC voltage and supplying the zero-crossing signal in relation to zero-crossing events in the AC voltage. Zero-crossing events are the periodic times at which the AC voltage has a voltage level of about 0V. For example, this may occur when the node V_{ACHOT}, which receives a hot, or varying, voltage associated with the AC source 158, has a voltage level of about 0V with respect to the node V_{ACNEUT.}, which receives a neutral, or non-varying, voltage associated with the AC source 158. The zero-crossing signal is a voltage signal which may comprise a pulse, a square wave, or some other voltage signal to convey information about zero-crossing events in the AC voltage. One version of the zero-crossing detector 268, illustrated in the circuit schematic view of FIG. 8, comprises: (i) a bridge rectifier 272, (ii) an LED 276 connected to the bridge rectifier 272 through a resistor 278, (ii) a photo-transistor 280 optically coupled to the LED 276, and (iv) an inverter-buffer 284 comprising a transistor 286 to generate the zero-crossing signal. For example, the photo-transistor 280 can be configured to substantially turn off at a zero-crossing event. In this version, the zero-crossing signal, appearing after the inverter-buffer 284, is an inverted voltage pulse, having a normally high value when there is no zero-crossing event, and a low value when there is a zero-crossing event.

In one version, the voltage level selector 248 also comprises a timer 288 to generate and deliver the trigger signal to the trigger circuit 188 of the DC voltage supply 164. The timer 288 is capable of receiving the zero-crossing signal from the zero-crossing detector 268 and is coupled to the capacitor and switched resistor network 250. The timer 288 generates the trigger signal in relation to the zero-crossing signal and the time constant t_{RC} to adjust the level of the input voltage hysteresis of the rectifier 168 to suitably select the voltage level of the DC voltage. For example, in one version, the trigger signal is a voltage pulse as a function of time, the voltage pulse having a leading voltage upswing at about a first time t₁ and a trailing voltage downswing at about a second time t₂. The trigger circuit 188 of the rectifier 168, in response to the trigger signal, can turn the rectifier 168 off at t₁. and turn the rectifier 168 on at t₂. The trigger signal is also capable repeating this turning on and turning off of the rectifier 168 periodically in tune with the period of the AC voltage, essentially generating a series of times t₁₍ₖ₎ and t₂₍ₖ₎, where k is an incrementing integer. Thus, in response to the trigger signal, the rectifier 168 generates a rectified voltage for a percentage P₁ of the period of the AC voltage, P₁ being the portion of the period starting at time t₂₍₁₎ and continuing to time t₁₍₂₎ in the next period of the AC voltage, and not generating a rectified voltage for a percentage P₂ of the period of the AC voltage, P₂ being equal to (1−P₁). Thus, the selection of the times t₁, and t₂ can be used to select the amount of time during which the rectifier 168 is producing a rectified voltage, and thus ultimately the voltage level of the DC voltage produced by the voltage multiplier 172. The timer 288 generates the trigger signal, and selects the times t₁ and t₂, in relation to the time constant t_{RC} and the zero-crossing signal. For example, in one version, the time t₁ is selected in relation to the zero-crossing signal and the time t₂ is selected in relation to the time constant t_{RC}.

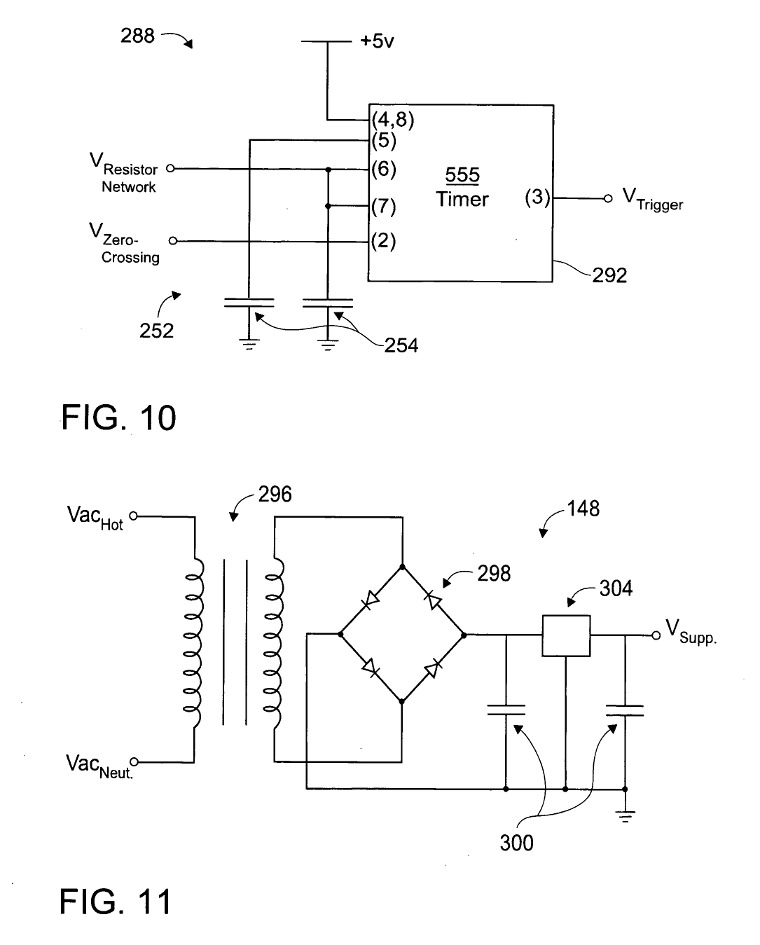

In one version, for example as illustrated in the circuit schematic view of FIG. 10, the timer 288 comprises a 555 timer chip 292. The 555 timer chip 292 is capable of generating a periodic control signal in response to input signals. For example, the 555 timer chip 292 is capable of generating the trigger signal in response to the zero-crossing signal generated by the zero-crossing detector 268, and the time constant t_{RC}, which is coupled to the 555 timer chip 292 by connecting the capacitor portion 252 and the switched-resistor portion 256 of the network 250 to the 555 timer chip 292. For example, in FIG. 10, capacitors 254 of the capacitor portion 252 of the capacitor and switched-resistor network 250 are connected to pins 5, 6 and 7 of the 555 timer chip 292, and the resistor portion 256 of the network 250 are connected to pins 6 and 7. Additionally, the zero-crossing signal can be connected to pin 2, and the output of the timer 288, the trigger signal, can be taken from pin 3. The pin layout of 555 timer chips 292 typically follow a standard pin layout that is the same on most 555 timer chips 292 commercially available. Suitable 555 timer chips 292 are available from Texas Instruments, Motorola Corp, and can be for example, a LMC 555 CN timer chip available from National Semiconductor Co, Santa Clara, Calif.

In one version, the power supply 136 comprises a plurality of electrode power supplies 144. For example, in a version of the ion exchange apparatus 20 comprising two electrochemical ion exchange cells 24a,b, the power supply 136 may comprise two electrode power supplies (not shown) each electrode power supply 144 capable of generating a DC voltage having a selectable voltage level and polarity for a pair of electrodes 40,42 in one of the electrochemical ion exchange cells 24. In one version, each electrode power supply 144 independently comprises necessary components, for example, the components shown in the embodiment illustrated in FIG. 3. However, in another version, a plurality of electrode power supplies 144 may have certain components in common. For example, a power supply 136 comprising a plurality of electrode power supplies 144 may have only a single zero-crossing detector 268, as the zero-crossing signal generated by the zero-crossing detector 268 is dependent only upon the AC voltage, and thus may be commonly used by each of the plurality of electrode power supplies 144.

In one version, the power supply 136 also comprises one or more supplemental power supplies 148. In one version, the supplemental power supply 148 is capable of generating a supplemental DC voltage to deliver power to components of the ion exchange apparatus 20 other than the electrodes 40,42. In one version, the supplemental power supply 148 is capable of generating the supplemental DC voltage having a voltage level of from about 1 Volts to about 30 Volts, for example, a DC voltage supply generating 5 Volts to power the microprocessor of the controller 132. Another power supply generating 12 Volts can be used to power the electric motor 128 of the valve. The microprocessor power supply should have a low voltage ripple of less than about 0.1 Volts. One version of the supplemental power supply 148 is illustrated in the circuit schematic view of FIG. 11, and comprises a transformer 296, a bridge rectifier 298, at least one capacitor 300, and a voltage regulator 304.

The ion exchange apparatus 20 typically comprises one or more sensors 308 to sense a property of a component of the apparatus 20. The sensor 308 may detect an event or measure a property. For example, the sensor 308 may be a position sensor 308 that senses the position of the rotor in the valve 116 or detects the arrival of the rotor at a certain position. In another example, the sensor 308 may be a conductivity ion sensor 308 that measures directly or indirectly the concentration of ions in the fluid being treated by the ion exchange apparatus 20. The sensor 308 may be placed at certain points in the fluid stream such as, for example, at the inlet 32 or outlet 36 of the electrochemical ion exchange cell 24, or at a combination of these locations or others. The sensor 308 can be also temperature or valve position sensors.

In one version, the controller 132 receives signals from the sensors 308 and may use these signals to generate control signals for the power supply 136, such as the time-constant selection signal. For example, the microcontroller 152 may generate a time-constant selection signal that is in relation to both signals from the power supply 136, such as the current detection signal, and a signal from the sensor 308, such as an ion concentration signal. In another example, the microcontroller 152 may also generate the polarity selection signal in response to signals from the sensor 308. In another version, the controller 132 may use a combination of signals, such as those generated by the power supply 136 and the sensor 308, to generate a series of control signals for the power supply 136. For example, the controller 132 may generate a time-constant selection signal and a polarity selection signal that evolve in time in response to conditions in the apparatus 20. sensed by the sensor 308 and conditions in the power supply 136 or the apparatus 20 communicated by the power supply 136 to the controller 132, for example communicated by the current detection signal.

The present invention has been described with reference to certain preferred versions thereof; however, other versions are possible. For example, the power supply can be used in other types of applications, as would be apparent to one of ordinary skill, such as to power a motorized tap to control the water or fluid output. Also, the various components of the power supply described to illustrate an exemplary power supply can be substituted by other equivalent components as would be apparent to those of ordinary skill in the art. Therefore, the spirit and scope of the appended claims should not be limited to the description of the preferred versions contained herein.

What is claimed is:

1. An electrode power supply for an electrochemical ion exchange cell having electrodes, the electrode power supply having output terminals and being capable of receiving an AC voltage and generating a DC voltage for the electrodes at the output terminals, the electrode power supply comprising:
(a) a DC voltage supply capable of producing a DC voltage having selectable voltage levels from the AC voltage;
(b) a current detector to detect the current level of the DC voltage at the output terminals;
(c) a voltage selector to select the voltage level of the DC voltage in relation to the detected current level; and
(d) a polarity selector to select the polarity of the DC voltage relative to the output terminals.

2. An electrode power supply according to claim 1 wherein the DC voltage supply comprises an adjustable-hysteresis rectifier and a voltage multiplier.

3. An electrode power supply according to claim 2 wherein the current detector is capable of generating a current detection signal.

4. An electrode power supply according to claim 3 wherein the voltage selector generates a trigger signal for the rectifier, the trigger signal being in relation to the current detection signal.

5. An electrode power supply according to claim 4 wherein the rectifier is a full-wave rectifier which is capable of receiving the AC voltage and the trigger signal and which has an input voltage hysteresis equal to the difference in voltage between a first AC voltage value input to the rectifier that causes the rectifier to turn on and a second AC voltage value input to the rectifier that causes the rectifier to turn off.

6. An electrode power supply according to claim 5 wherein the rectifier comprises an SCR and a trigger circuit, the trigger circuit capable of receiving the trigger signal.

7. An electrode power supply according to claim 6 wherein the trigger circuit comprises a photo-DIAC which is optically coupled to an LED.

8. An electrode power supply according to claim 6 wherein the trigger circuit is connected to the gate of the SCR.

9. An electrode power supply according to claim 2 wherein the voltage multiplier is a voltage doubler.

10. An electrode power supply according to claim 2 wherein the voltage multiplier comprises a diode and a plurality of capacitors.

11. An electrode power supply according to claim 1 comprising a pair of output terminals and wherein the polarity selector selects the polarity of the DC voltage relative to the pair of output terminals.

12. An electrode power supply according to claim 11 wherein the polarity selector is capable of receiving a polarity selection signal.

13. An electrode power supply according to claim 12 wherein the polarity selector comprises a relay capable of receiving the polarity selection signal.

14. A controlled electrode power supply comprising the electrode power supply according to claim 12 and a microcontroller to generate the polarity selection signal.

15. An electrode power supply according to claim 1 wherein the current detector comprises a sense resistor, an LED connected across the sense resistor, and a photo-transistor optically coupled to the LED.

16. A controlled electrode power supply comprising the electrode power supply according to claim 3 and a microcontroller to receive the current detection signal from the current detector and generate a time-constant selection signal in relation to the current detection signal.

17. An electrode power supply according to claim 4 wherein the voltage level selector comprises:
(a) a zero-crossing detector to generate a zero-crossing signal as a function of time in relation to the periodic times at which that the AC voltage has a zero crossing event;
(b) a capacitor and switched-resistor network having a time constant t_{RC} and capable of receiving a time-constant selection signal; and
(c) a timer to generate the trigger signal received by the trigger circuit in relation to the time constant t_{RC} and the zero-crossing signal.

18. An electrode power supply according to claim 17 wherein the voltage level selector generates a trigger signal which is a voltage pulse as a function of time, the voltage pulse having a leading voltage upswing at a first time t₁ and a trailing voltage downswing at a second time t₂, and wherein the values of t₁ and t₂ depend upon the zero-crossing signal and the time constant t_{RC}.

19. An electrode power supply according to claim 17 wherein the capacitor and switched resistor network comprises a plurality of capacitors connected to the timer, a plurality of resistors, and a plurality of relays connecting the plurality of resistors to the timer, the relays capable of receiving the time-constant selection signal.

20. An electrode power supply according to claim 17 wherein the timer comprises a 555 timer chip which generates the trigger signal.

21. An electrode power supply according to claim 17 wherein the zero-crossing detector comprises (i) a bridge rectifier, (ii) an LED connected to the bridge rectifier through a resistor, (iii) a photo-transistor optically coupled to the LED, and (iv) an inverter comprising a transistor to generate the zero-crossing signal; and wherein the photo-transistor is configured to substantially turn off when the AC voltage has a zero-crossing event.

22. A controlled electrode power supply comprising the electrode power supply according to claim 17 and a microcontroller, wherein the microcontroller is capable of generating the time-constant selection signal.

23. A power supply comprising the electrode power supply according to claim 1 and a supplemental power supply to generate a supplemental DC voltage.

24. A power supply according to claim 23 wherein the electrode power supply is capable of generating a DC voltage having a selectable voltage level of from about 0 Volts to about 330 Volts and the supplemental power supply is capable of generating a DC voltage having a voltage level of from about 1 Volt to about 30 Volts.

25. A power supply according to claim 24 wherein the supplemental power supply comprises a transformer, a bridge rectifier, a capacitor and a voltage regulator.

26. A controlled power supply for an ion exchange apparatus, the ion exchange apparatus comprising a motor and electrochemical ion exchange cell having electrodes, the power supply comprising:
(a) an electrode power supply having an output terminal, the electrode power supply capable of receiving an AC voltage and generating a DC voltage for the electrodes at the output terminal, the electrode power supply comprising:
(i) a DC voltage supply capable of producing a DC voltage having selectable voltage levels from the AC voltage;
(ii) a current detector to detect the current level of the DC voltage at the output terminal;
(iii) a voltage selector to select the voltage level of the DC voltage in relation to the detected current level; and
(iv) a polarity selector to select the polarity of the DC voltage relative to the output terminal;
(b) a supplemental power supply to generate a supplemental DC voltage for the electric motor; and
(c) a microcontroller to generate control signals for the electrode power supply and the electric motor.

27. A controlled power supply according to claim 26 wherein the current detector is capable of generating a current detection signal in relation to the detected current level for the microcontroller, and the microcontroller is capable of generating a polarity selection signal for the polarity selector, and a time-constant selection signal for the voltage selector in relation to the current detection signal.

28. A controlled power supply according to claim 27 wherein the DC voltage supply comprises an rectifier and a voltage multiplier, the rectifier capable of receiving the AC voltage.

29. A controlled power supply according to claim 28 wherein the voltage level selector comprises a zero-crossing detector capable of receiving the AC voltage and generating a zero-crossing signal, a capacitor and switched-resistor network having a time constant t_{RC} and capable of receiving the time constant selection signal, and a timer to generate a trigger signal for the rectifier and capable of receiving the zero-crossing signal.

30. An ion exchange apparatus comprising:
(a) an electrochemical cell having a fluid channel comprising a fluid inlet and a fluid outlet, and electrodes about the fluid channel and a water-splitting ion exchange membrane;
(b) a valve to control the flow of a solution through the fluid inlet, fluid outlet, and the fluid channel of the electrochemical cell;
(c) a motor to move a rotor in the valve; and
(d) a controller to control the operation of the electrochemical cell, the valve and the electric motor, the controller comprising:
(ii) a power supply having an electrode power supply and a supplemental power supply, the electrode power supply having an output terminal and being capable of receiving an AC voltage and generating a DC voltage for the electrodes at the output terminal, the electrode power supply comprising:
(1) a DC voltage supply capable of producing a DC voltage having selectable voltage levels from the AC voltage;
(2) a current detector to detect the current level of the DC voltage at the output terminal;
(3) a voltage selector to select the voltage level of the DC voltage in relation to the detected current level; and
(4) a polarity selector to select the polarity of the DC voltage relative to the output terminal; and
(i) a control module having a microcontroller to generate control signals for the power supply and the electric motor.

31. An ion exchange apparatus according to claim 30 wherein the valve, the electrochemical cell, and the electric motor have sensors capable of generating sensor signals and the microcontroller is capable of receiving the sensor signals and generates the control signal in relation to the sensor signals.

32. A method of maintaining a selectable voltage across electrodes of an electrochemical cell, the method comprising:
(a) rectifying an AC voltage and multiplying the rectified voltage to produce a pulsating DC voltage having a time-averaged value equal to the amplitude of the AC voltage multiplied by a multiplier M₁;
(b) applying the pulsating DC voltage across the electrodes;
(c) measuring the current level delivered to the electrodes; and
(d) setting the value of the multiplier M₁ in relation to the measured current level.

33. A method according to claim 32 wherein (a) comprises (i) rectifying the AC voltage and generating a rectified voltage for a percentage P₁ of the period of the AC voltage and (ii) not rectifying the AC voltage and not producing a rectified voltage for a percentage P₂ of the period of the AC voltage, where P₂ is equal to (1−P₁).

34. A method according to claim 33 wherein (d) comprises selecting the percentage P₁ in relation to the measured current level.

35. A method according to claim 34 wherein increasing the value of the multiplier M₁ comprises increasing the percentage P₁.

36. A method according to claim 32 wherein the AC voltage has an amplitude of from about 80 V to about 480 V and (d) comprises selecting the multiplier M₁ to have a value of from about 2 to about 5.

37. A method of maintaining a selectable voltage across electrodes of an electrochemical cell, the method comprising:
(a) rectifying an AC voltage and multiplying the rectified voltage to produce a pulsating DC voltage having a time-averaged value equal to the amplitude of the AC voltage multiplied by a multiplier M₁;
(b) applying the pulsating DC voltage across the electrodes and maintaining a selected polarity of the DC voltage across the electrodes;
(c) sensing a property of the electrochemical cell; and
(d) selecting the value of the multiplier M₁ and the polarity of the pulsating DC voltage across the electrodes in relation to the sensed property of the electrochemical cell.

38. A method according to claim 37 wherein (c) comprises maintaining a sensor in the electrochemical cell.

39. A method according to claim 37 wherein (c) comprises sensing at least one of (i) the conductivity of a solution passing through the electrochemical cell, (ii) the temperature in the electrochemical cell, (iii) the concentration of an ion or chemical species in the solution, and (iv) the current level delivered to the electrodes in (b).
